(19) United States
(12) Patent Application Publication
(10) Pub. No.: US 2007/0122694 A1
(43) Pub. Date: May 31, 2007

(54) Non-aqueous electrolyte secondary battery

(76) Inventors: Junichi Yamaki, Fukuoka (JP); Shigeto Okada, Fukuoka (JP); Kenta Ishida, Fukuoka (JP); Takayuki Doi, Fukuoka (JP)

Correspondence Address: MCDERMOTT WILL & EMERY LLP, 600 13TH STREET, N.W., WASHINGTON, DC, 20005-3096, US

(21) Appl. No.: 11/598,820

(22) Filed: Nov. 14, 2006

(30) Foreign Application Priority Data
Nov. 14, 2005 (JP) 2005-328749

(51) Int. Cl. H01M 2/16; H01M 4/58

(52) U.S. Cl. 429/137; 429/246; 429/231.95; 429/251

(57) ABSTRACT

A non-aqueous electrolyte secondary battery including a positive electrode capable of absorbing and desorbing lithium, a negative electrode capable of absorbing and desorbing lithium, a separator, and a non-aqueous electrolyte, wherein the positive electrode includes a positive electrode active material having a redox potential of not less than 4.5 V relative to a lithium electrode, a coating film is formed on a surface of the positive electrode, and the coating film includes inorganic fine particles and a polymer having a methyl methacrylate unit.

### FIELD OF THE INVENTION

The present invention relates to a non-aqueous electrolyte secondary battery, and more particularly to a non-aqueous electrolyte secondary battery comprising a positive electrode active material having a high redox potential.

### BACKGROUND OF THE INVENTION

Non-aqueous electrolyte secondary batteries such as lithium ion secondary batteries have a nominal voltage of 3.5 to 3.7 V, which is three times higher than the nominal voltage (1.2 V) of nickel hydrogen storage batteries. For this reason, non-aqueous electrolyte secondary batteries are incorporated in various portable devices as a power source capable of offering high energy density.

A technique for further enhancing the energy density of batteries is to increase the potential of the positive electrode to not less than 4.5 V relative to a lithium electrode by using a material having a high redox potential as a positive electrode active material. This technique also increases the voltage of batteries. Accordingly, when a plurality of batteries are connected in series so as to obtain a desired voltage, the number of batteries connected in series can be reduced by about 30% compared to conventional non-aqueous electrolyte secondary batteries. That is, the occupancy of non-aqueous electrolyte secondary batteries in a device can be reduced.

On the other hand, when a negative electrode comprising, instead of conventionally used graphite, a high capacity alloy containing Si and a positive electrode comprising LiCoO₂ are combined to produce a non-aqueous electrolyte secondary battery, the voltage of the battery decreases by about 0.3 V compared to a battery having a negative electrode comprising graphite and the same positive electrode. Accordingly, to achieve a high capacity while retaining a battery voltage equal to that of conventional batteries, the use of a positive electrode active material having a redox potential of not less than 4.5 V relative to a lithium electrode is required.

It is, however, difficult to obtain a non-aqueous electrolyte that can withstand such a high positive electrode potential. Conventionally used non-aqueous electrolytes, when used together with a positive electrode having a high potential, are usually decomposed by oxidation during the repetition of charge and discharge.

In order to prevent the decomposition of non-aqueous electrolyte when it is used with a positive electrode active material having a redox potential of not less than 4.5 V relative to a lithium electrode, for example, the addition of a cyclic sulfonic acid ester to a non-aqueous electrolyte is proposed (e.g., Japanese Laid-Open Patent Publication No. 2005-149750). Japanese Laid-Open Patent Publication No. 2005-149750 discloses that the cyclic sulfonic acid ester functions as an agent for forming a protection film on a positive electrode.

According to the technique disclosed by this patent publication, however, when a protection film is formed on a positive electrode, a relatively thick coating film is also formed on a negative electrode, which increases the internal resistance of the battery. This technique thus fails to enhance cycle characteristics sufficiently.

The present invention has been made to address the above problem. It is an object of the present invention to provide a non-aqueous electrolyte secondary battery having a high energy density and excellent cycle characteristics.

### BRIEF SUMMARY OF THE INVENTION

A non-aqueous electrolyte secondary battery of the present invention comprises a positive electrode capable of absorbing and desorbing lithium, a negative electrode capable of absorbing and desorbing lithium, a separator, and a non-aqueous electrolyte. The positive electrode comprises a positive electrode active material having a redox potential of not less than 4.5 V relative to a lithium electrode. A coating film is formed on a surface of the positive electrode. The coating film comprises inorganic fine particles and a polymer having a methyl methacrylate unit.

The inorganic fine particles are preferably contained in the coating film in an amount of 1 to 300 parts by weight per 100 parts by weight of the polymer. Preferably, the inorganic fine particles comprise at least one selected from the group consisting of SiO₂, Al₂O₃, TiO₂, Y₂O₃ and MgO. The coating film preferably has a thickness of 0.1 to 10 μm.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic vertical cross sectional view of a non-aqueous electrolyte secondary battery according to one embodiment of the present invention.

FIG. 2 is a schematic diagram showing an enlarged surface portion of a positive electrode contained in a non-aqueous electrolyte secondary battery according to one embodiment of the present invention.

### DETAILED DESCRIPTION OF THE INVENTION

The non-aqueous electrolyte secondary battery of the present invention comprises a positive electrode capable of absorbing and desorbing lithium, a negative electrode capable of absorbing and desorbing lithium, a separator, and a non-aqueous electrolyte.

The positive electrode comprises a positive electrode material mixture containing a positive electrode active material having a redox potential of not less than 4.5 V relative to a lithium electrode (hereinafter, the potential relative to a lithium electrode is simply expressed by “V (vs. Li)”). The negative electrode comprises a negative electrode material mixture containing a negative electrode active material. The positive and negative electrodes may comprise only a material mixture containing an active material, or a current collector and a material mixture layer carried on the current collector.

The positive electrode has a coating carried on a surface thereof. The coating comprises inorganic fine particles and a polymer having a methyl methacrylate unit. This coating film covers highly active sites of the positive electrode active material. Accordingly, even when the end-of-charge voltage is high, the decomposition of non-aqueous electrolyte by oxidation caused by the highly active sites of positive electrode active material is prevented. Further, in the conventional technique in which an agent for forming a protection film is added to a non-aqueous electrolyte, a coating film is also formed on the negative electrode in addition to the positive electrode, whereas in the present invention, the covering of the positive electrode with a coating film is enough, and there is no need to cover the negative electrode with a coating film. Therefore, the increase of internal resistance caused by the formation of a coating film on the negative electrode surface can be prevented. Accordingly, even when the end-of-charge voltage is increased, the cycle characteristics of the battery can be improved compared to those of conventional batteries.

It is difficult to form an ion-conductive coating film using only a polymer. By incorporating inorganic fine particles into the coating film, however, the non-aqueous electrolyte can exist at the interface between the inorganic fine particles and the polymer. Thereby, the inorganic fine particles are connected to each other, forming a path through which ions can pass. This ensures ionic conductivity. In other words, the inorganic fine particles serve to ensure the ionic conductivity of the coating film.

The polymer containing a methyl methacrylate unit is highly resistant to oxidation at a high voltage. Accordingly, even when the positive electrode has a potential of not less than 4.5 V (vs. Li), for example, the polymer containing a methyl methacrylate unit does not transform by oxidation or the like. It is therefore possible to prevent the degradation of the coating film at a high voltage.

The coating film is preferably formed such that it covers a portion of the positive electrode material mixture in contact with the non-aqueous electrolyte. In the case where the positive electrode comprises only a positive electrode material mixture containing a positive electrode active material such as a coin type battery, for example, the coating film is preferably formed on the entire positive electrode material mixture except the surface of the positive electrode material mixture in contact with the battery case. In the case where the positive electrode comprises a positive electrode current collector and a positive electrode material mixture layer formed on the current collector, the coating film is preferably formed on the entire positive electrode material mixture layer except the surface of the positive electrode material mixture layer in contact with the positive electrode current collector. Furthermore, because the positive electrode material mixture is porous, the coating film preferably covers the surface of the active material and that of conductive material contained in the electrode.

The redox potential of the positive electrode active material can be determined by the following procedure, for example.

Specifically, a battery is constructed using a positive electrode containing the positive electrode active material, a negative electrode comprising a lithium foil, a polyethylene separator interposed between the positive and negative electrodes and a non-aqueous electrolyte. The non-aqueous electrolyte can be a conventional electrolyte prepared by, for example, dissolving LiPF₆ in a solvent mixture of ethylene carbonate and ethyl methyl carbonate at a volume ratio of 1:3 at a LiPF₆ concentration of 1.2 mol/L.

At a temperature of 25° C., the obtained battery is charged at a current of 5 mA per unit weight of the positive electrode active material contained in the positive electrode until the battery voltage reaches not less than 4.5 V. After the charging, the battery is allowed to stand for 1 hour, and the battery voltage is measured. When the measured battery voltage is not less than 4.5 V, the positive electrode active material can be deemed to have a redox potential of 4.5 V (vs. Li).

Examples of the positive electrode active material that satisfies the above condition include LiNi_{0.5}Mn_{1.5}O₄ (4.7V), LiCoPO₄ (4.8V), Li₂CoPO₄F (4.8V), LiNiPO₄ (5.3V) and LiNiVO₄ (4.8V).

The amount of the inorganic fine particles contained in the coating film is preferably 1 to 300 parts by weight per 100 parts by weight of the polymer. When the amount of the inorganic fine particles is less than 1 part by weight per 100 parts by weight of the polymer, the ionic conductivity of the coating film is low, so the cycle characteristic of the battery decreases slightly. When the amount of the inorganic fine particles exceeds 300 parts by weight, the amount of non-aqueous electrolyte retained in the coating film will be too large, so the effect of preventing the decomposition of non-aqueous electrolyte by oxidation decreases. As a result, the cycle characteristics degrade slightly.

The coating film preferably has a thickness of 0.1 to 10 μm. When the coating film has a thickness of less than 0.1 μm, the uniform coating film is not obtained, that is, uncovered areas (i.e., areas which are not covered with the coating film) are formed on the surface of the positive electrode active material layer. As a result, the decomposition of non-aqueous electrolyte by oxidation proceeds excessively. As such, the effect of the present invention cannot be obtained. When the coating film has a thickness exceeding 10 μm, the formed coating film is too thick, reducing the ionic conductivity and increasing the reaction resistance. As a result, the cycle characteristics degrade slightly.

The inorganic fine particles contained in the coating film can be any fine particles comprising various inorganic materials. Preferably, the inorganic fine particles comprise at least one selected from the group consisting of SiO₂, Al₂O₃, TiO₂, Y₂O₃ and MgO because the inorganic fine particles of these materials are electrochemically stable, highly resistant to oxidation at a high voltage and capable of retaining non-aqueous electrolyte.

It is preferred that the average particle size of the inorganic fine particles be sufficiently smaller than the thickness of the coating film. Preferably, the inorganic fine particles have an average particle size of 0.005 to 3 μm.

The polymer may comprise only a methyl methacrylate unit, or it may comprise a methyl methacrylate unit and a monomer unit other than the methyl methacrylate unit. Examples of the monomer unit other than the methyl methacrylate unit include methacrylic acid ester, methacrylonitrile, acrylic acid ester, acrylonitrile, acrylophenone, ethylene type hydrocarbon, vinyl ester, vinyl sulfone, cycloalkylethylene and styrene. A polyfunctional polymerizable monomer can also be used such as 1,4-butanediol dimethacrylate or trimethylolpropane trimethacrylate.

An example of the polymer having a methyl methacrylate unit is polymethyl methacrylate.

When the polymer contains a monomer unit other than the methyl methacrylate unit, the monomer unit other than the methyl methacrylate unit is preferably contained in the polymer in such an amount that does not degrade the resistance to oxidation at a high voltage of the polymer.

Hereinafter, the present invention will be described with reference to the accompanying drawings.

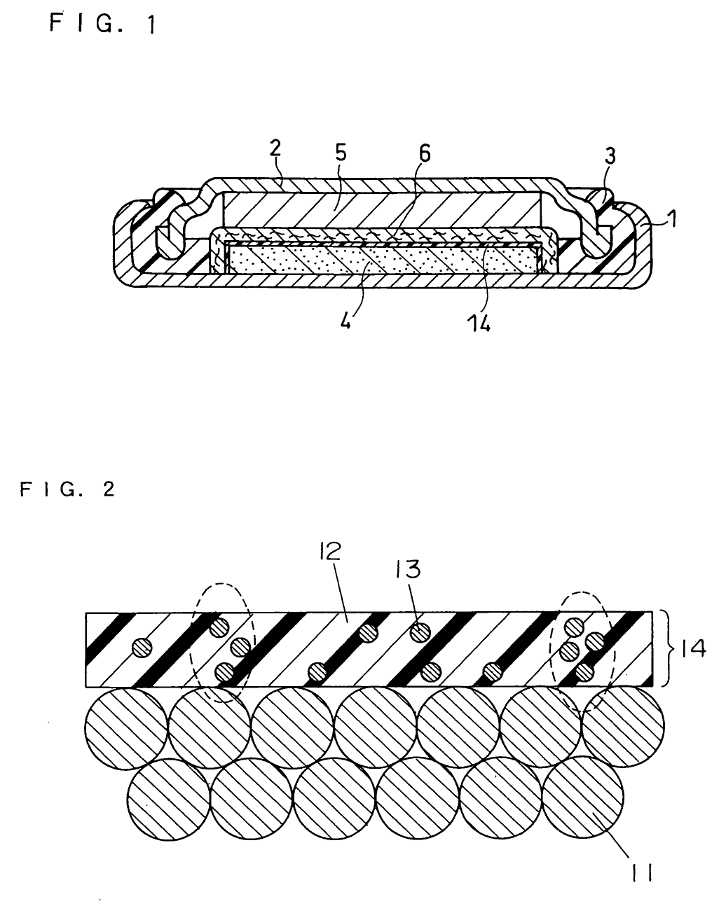

FIG. 1 shows a non-aqueous electrolyte secondary battery according to an embodiment of the present invention. In the coin-type battery of FIG. 1, the positive electrode comprises only a positive electrode material mixture. The negative electrode comprises only a negative electrode material mixture.

The battery of FIG. 1 comprises a positive electrode 4, a negative electrode 5, a separator 6 interposed between the positive electrode 4 and the negative electrode 5, and a non-aqueous electrolyte (not shown). The positive electrode 4 is disposed on the inner surface of a positive electrode case 1. Likewise, the negative electrode 5 is disposed on the inner surface of a negative electrode case 2. A gasket 3 is placed on the periphery of the negative electrode case 2. The opening edge of the positive electrode case 1 is crimped onto the periphery of the negative electrode case 2 with the gasket 3 therebetween.

On the surface of the positive electrode is formed a coating film 14 comprising inorganic fine particles and a polymer containing a methyl methacrylate unit. FIG. 2 shows a schematic diagram showing an enlarged surface portion of the positive electrode. As can be seen from FIG. 1, the coating film 14 is formed on the surface of the positive electrode material mixture facing the negative electrode as well as on the side faces of the positive electrode material mixture. The positive electrode material mixture contains, in addition to the positive electrode active material, a conductive material and a binder. The coating film 14 also covers the surface of the active material and that of the conductive material contained in the electrode (not shown).

In the coating film 14 comprising a polymer containing a methyl methacrylate unit 12 and inorganic fine particles 13, because a microscopic space is created between adjacent inorganic fine particles 13 in the coating film 14, in an area where the inorganic fine particles 13 are close to each other (as indicated by dotted circles in FIG. 2), a path through which the non-aqueous electrolyte can pass is formed. The formation of such paths ensures the ionic conductivity. In the area of the coating film other than the paths, on the other hand, the non-aqueous electrolyte cannot contact with the positive electrode active material 11. Accordingly, it is presumed that this coating film prevents the decomposition of non-aqueous electrolyte by oxidation. The mechanism by which microscopic spaces are created among the inorganic fine particles 13 in the coating film 14 is not known, but the low affinity between the inorganic fine particles and the polymer having a methyl methacrylate unit is considered to be a factor.

As described above, because in the coating film formed on the positive electrode, the paths through which the non-aqueous electrolyte can pass are formed, the positive electrode active material and the non-aqueous electrolyte come into contact with each other in such a condition as to ensure ionic conductivity. Accordingly, the decomposition of non-aqueous electrolyte by oxidation at a high voltage occurs in a microscopic level. However, due to the effect of the coating film formed on the surface of the positive electrode, the contact area between the non-aqueous electrolyte and the positive electrode active material is very small. For this reason, the rate of deterioration of battery characteristics caused by the decomposition of non-aqueous electrolyte by oxidation can be reduced significantly.

The coating film comprising inorganic fine particles and a polymer having a methyl methacrylate unit can be formed on the surface of the positive electrode in the following manner.

A polymer having a methyl methacrylate unit is dissolved in a specified solvent. To the resulting solution is added inorganic fine particles so as to prepare a paint. The obtained paint is applied onto the surface of the positive electrode, which is then dried. In this manner, the coating film containing inorganic fine particles and a polymer having a methyl methacrylate unit is formed on the surface of the positive electrode.

Examples of the solvent for dissolving the polymer include acetone, benzene, ethanol, 2-propanol, pentanol, hexanol, ethylene glycol, propylene glycol, 3-methyl-3-methoxybutanol, benzyl alcohol, γ-butyrolactone, N-methyl-2-pyrrolidone, dimethylacetamide, propylene glycol monomethyl ether, propylene glycol monomethyl ether acetate, methyl ethyl ketone, methyl isobutyl ketone, dimethylacetamide and N,N-dimethylformamide. They may be used singly or in any combination of two or more.

The paint can be prepared by a known mixing method. The paint can be applied onto the surface of the positive electrode by a known application method. Examples of the application method include spin coating, casting and screen-printing.

The positive electrode material mixture contained in the positive electrode can contain the positive electrode active material, a conductive material and a binder.

The conductive material added to the positive electrode can be any material for conductive material known in the pertinent art, such as carbon black. The binder added to the positive electrode can be any material for binder known in the pertinent art. Examples of the binder include polyvinylidene fluoride and polytetrafluoroethylene.

The positive electrode consisting of the positive electrode material mixture can be produced by, for example, forming a material mixture paste into a sheet, followed by drying. The material mixture paste is prepared using the positive electrode active material, conductive material, binder and a specified dispersing medium. The positive electrode consisting of a positive electrode current collector and a positive electrode material mixture layer can be produced by, for example, applying the above material mixture paste onto a positive electrode current collector, followed by drying. To adjust the thickness of the positive electrode material mixture layer, the positive electrode material mixture layer may be rolled by rollers.

The negative electrode material mixture contained in the negative electrode contains, for example, a negative electrode active material, a binder and optionally a conductive material. As the negative electrode active material, a material capable of absorbing and desorbing lithium can be used. Examples of such material include graphite, Si powder, Sn powder, an alloy containing Si and an alloy containing Sn. Alternatively, a foil made of metal lithium or a foil made of a lithium alloy can be used instead of the negative electrode material mixture.

Among the above, an alloy containing Si is preferred to use as the negative electrode active material because it has a low potential and can offer high capacity. By the combined use of this negative electrode active material and the above-described positive electrode active material, it is possible to set the end-of-charge voltage to about 4.2 to 5.0 V. Thereby, it is possible to provide a high capacity battery having an end-of-charge voltage equal to or higher than conventional batteries.

As the conductive material added to the negative electrode, the materials listed for the conductive material added to the positive electrode can be used. The binder added to the negative electrode can be any material for binder known in the pertinent art. Examples of such material include polyvinylidene fluoride and styrene butadiene rubber.

The negative electrode consisting of the negative electrode material mixture and the negative electrode consisting of a negative electrode current collector and a negative electrode material mixture layer carried on the current collector can be produced in the same manner as described for the positive electrode.

In the battery of FIG. 1, the positive electrode material mixture and the negative electrode material mixture may be carried on a positive electrode current collector and a negative electrode current collector, respectively. In this case, the positive electrode current collector is disposed in contact with the positive electrode case and the negative electrode current collector is disposed in contact with the negative electrode case.

The positive electrode current collector can be made of any material known in the pertinent art, such as aluminum. The negative electrode current collector can be made of any material known in the pertinent art, such as copper.

The non-aqueous electrolyte comprises a non-aqueous solvent and a solute dissolved in the solvent. Examples of the non-aqueous solvent include ethylene carbonate, ethyl methyl carbonate, diethyl carbonate and dimethyl carbonate. They may be used singly or in any combination of two or more.

The solute can be a lithium salt such as LiPF₆ or LiBF₄. These solutes may be used singly or in any combination of two or more.

The separator can be made of any material known in the pertinent art. Examples of such material include polyethylene, polypropylene, a mixture of polyethylene and polypropylene, and a copolymer of ethylene and propylene.

The shape of the lithium ion secondary battery of the present invention comprising the above-described positive electrode is not specifically limited. It may have a coin shape, sheet shape or prism shape. The non-aqueous electrolyte secondary battery of the present invention can be a large battery for use in electric vehicles. The electrode assembly contained in the non-aqueous electrolyte secondary battery of the present invention can be a stack type or spirally wound type.

The following describes the present invention with reference to examples.

### EXAMPLE 1

(Production of Positive Electrode)

The positive electrode active material used here was LiNi_{0.5}Mn_{1.5}O₄ having a redox potential of 4.7 V (vs. Li).

A material mixture paste was prepared by mixing 85 parts by weight of the positive electrode active material, 10 parts by weight of acetylene black serving as a conductive material and an N-methyl-2-pyrrolidone (NMP) solution containing polyvinylidene fluoride (PVDF) serving as a binder. The NMP solution containing PVDF was mixed such that the amount of PVDF added was 5 parts by weight.

The obtained material mixture paste was applied onto a 15 μm thick aluminum foil as a positive electrode current collector, followed by drying to form a positive electrode sheet having a thickness of 80 μm. This positive electrode sheet was punched into a disc having a diameter of 15 mm. Thereby, a positive electrode comprising a positive electrode current collector and a positive electrode material mixture was produced.

On a surface of the positive electrode material mixture, a coating film was formed as follows.

A paint, a precursor of coating film, was prepared by dispersing SiO₂ (average particle size: 10 nm, available from Aldrich Chemical Co. Inc.) serving as inorganic fine particles in a solution prepared by dissolving polymethyl methacrylate (PMMA) (average polymerization degree: 1000, available from Wako Pure Chemical Industries, Ltd.) in acetone. The amount of SiO₂ was 15 parts by weight per 100 parts by weight of polymethyl methacrylate.

The positive electrode produced as above was placed in a spin coater (1H-360S available from Mikasa Co., Ltd.). While the above-prepared paint was added dropwise to a surface of the positive electrode material mixture (including side faces) at a rate of 0.1 to 1 mL per cm², the positive electrode was rotated at 2000 to 5000 rpm for a specified length of time. Thereafter, the applied paint was dried at 80 to 100° C. This operation was repeated 1 to 3 times. Thereby, a positive electrode having a coating film formed on the surface of the positive electrode material mixture was produced.

In order to measure the thickness of the formed coating film, the positive electrode was cut, and the cut cross-section was observed by a scanning electron microscope (S-5500 available from Hitachi, Ltd.). As a result, the coating film had a thickness of 1 μm.

(Production of Negative Electrode)

A negative electrode was produced by punching out a foil of metal lithium having a thickness of 0.3 mm into a disc having a diameter of 17 mm.

(Assembly of Battery)

Using the positive and negative electrodes obtained above, a coin type battery as shown in FIG. 1 was produced.

The positive electrode was placed on the inner surface of a positive electrode case such that the positive electrode current collector was in contact with the inner surface. Subsequently, a separator (thickness: 20 μm) punched out into a disc was placed on the positive electrode. The separator used here was a polyethylene microporous film.

A non-aqueous electrolyte was injected into the positive electrode case in an amount of 0.1 g so as to immerse the positive electrode and the separator with the non-aqueous electrolyte. The non-aqueous electrolyte was prepared by dissolving lithium hexafluorophosphate (LiPF₆) in a solvent mixture of ethylene carbonate and ethyl methyl carbonate at a volume ratio of 1:3 at a LiPF₆ concentration of 1.2 mol/L.

On the separator was placed the negative electrode made of metal lithium. A negative electrode case equipped with a gasket on the periphery thereof was placed on the negative electrode. The opening edge of the positive electrode case was crimped onto the gasket. Thereby, a coin type battery was produced. This obtained battery was denoted as a battery of EXAMPLE 1.

### EXAMPLEs 2 to 5

Batteries of EXAMPLEs 2 to 5 were produced in the same manner as in EXAMPLE 1 except that the inorganic fine particles contained in the coating film was changed from SiO₂ to TiO₂ (EXAMPLE 2, average particle: 21 nm, available from Degussa AG.), Y₂O₃ (EXAMPLE 3, average particle: 33 nm, available from Nanometric Technology Inc.), Al₂O₃ (EXAMPLE 4, average particle: 13 nm, available from Ishihara Sangyo Kaisha, Ltd.) and MgO (EXAMPLE 5, average particle: 45 nm, available from Ube Material Industries, Ltd.).

### EXAMPLES 6 to 11

Batteries of EXAMPLEs 6 to 11 were produced in the same manner as in EXAMPLE 1 except that the amount of SiO₂ contained in the coating film was changed to 0.5 parts by weight (EXAMPLE 6), 1 part by weight (EXAMPLE 7), 30 parts by weight (EXAMPLE 8), 100 parts by weight (EXAMPLE 9), 300 parts by weight (EXAMPLE 10) and 400 parts by weight (EXAMPLE 11) per 100 parts by weight of polymethyl methacrylate.

### EXAMPLES 12 to 15

Batteries of EXAMPLEs 12 to 15 were produced in the same manner as in EXAMPLE 1 except that the thickness of the coating film was changed to 0.05 μm (EXAMPLE 12), 0.1 μm (EXAMPLE 13), 10 μm (EXAMPLE 14) and 15 μm (EXAMPLE 15) by controlling the time length of rotation of the spin coater.

### COMPARATIVE EXAMPLE 1

A battery of COMPARATIVE EXAMPLE 1 was produced in the same manner as in EXAMPLE 1 except that the coating film was not formed on the surface of the positive electrode material mixture.

### COMPARATIVE EXAMPLE 2

A battery of COMPARATIVE EXAMPLE 2 was produced in the same manner as in EXAMPLE 1 except that the coating film was not formed on the surface of the positive electrode material mixture, and that 1,3-propane sultone was added to the non-aqueous electrolyte. The amount of 1,3-propane sultone was 7 wt % of the non-aqueous electrolyte.

### COMPARATIVE EXAMPLE 3

A battery of COMPARATIVE EXAMPLE 3 was produced in the same manner as in EXAMPLE 1 except that the positive electrode active material was changed to LiCoO₂ having a redox potential of less than 4.5 V (vs. Li). When using LiCoO₂, the end-of-charge potential until which charge/discharge can be practically performed is about 4.4 V (vs. Li).

### COMPARATIVE EXAMPLE 4

A battery of COMPARATIVE EXAMPLE 4 was produced in the same manner as in EXAMPLE 1 except that the positive electrode active material was changed to LiCoO₂, and that the coating film was not formed on the surface of the positive electrode material mixture.

### COMPARATIVE EXAMPLE 5

A battery of COMPARATIVE EXAMPLE 5 was produced in the same manner as in EXAMPLE 1 except that the polymer contained in the coating film was changed from polymethyl methacrylate to styrene butadiene rubber (SBR).

Evaluation

The batteries produced above were evaluated as follows.

In an environment of 25° C., each battery was charged at a constant current density of 0.1 mA/cm² until the battery voltage reached 5 V. The charged battery was then discharged until the battery voltage decreased to 3 V. This charge/discharge cycle was performed 100 times. The rate of the discharge capacity at the 100th cycle to the discharge capacity at the first cycle was denoted as “capacity retention rate”. Note that the end-of-charge voltage was set to 4.2 V for the batteries of COMPARATIVE EXAMPLEs 3 and 4.

The results are shown in Table 1. In Table 1, the capacity retention rate is shown in percentage.

In the charge/discharge of each battery containing the above-described positive electrode active material (LiNi_{0.5}Mn_{1.5}O₄), the battery voltage sharply increased to 5 V immediately before the termination of charge of the battery. Even when the battery voltage sharply increased to 5 V, however, only the resistance inside the battery increased, and the battery was not actually charged. Accordingly, if each battery having the positive electrode active material is charged until the battery voltage reaches 5 V and then allowed to stand as, the battery voltage will decrease to about 4.7 V, that is, the redox potential of the positive electrode active material.

TABLE 1

| | | | Coating film | | | | |
|---|---|---|---|---|---|---|---|
| | | | | Inorganic fine | | | |
| | Positive Electrode | | | particles | | | |
| | Type of active | End-of-charge | | | Amount added | Thickness | Capacity retention |
| | material used | voltage (V) | Polymer | Type | (part by weight) | (μm) | rate (%) |
| Ex. 1 | LiNi_{0.5}Mn_{1.5}O₄ | 5 | PMMA | SiO₂ | 15 | 1 | 95.8 |
| Ex. 2 | LiNi_{0.5}Mn_{1.5}O₄ | 5 | PMMA | TiO₂ | 15 | 1 | 94.3 |
| Ex. 3 | LiNi_{0.5}Mn_{1.5}O₄ | 5 | PMMA | Y₂O₃ | 15 | 1 | 92.8 |
| Ex. 4 | LiNi_{0.5}Mn_{1.5}O₄ | 5 | PMMA | Al₂O₃ | 15 | 1 | 93.6 |
| Ex. 5 | LiNi_{0.5}Mn_{1.5}O₄ | 5 | PMMA | MgO | 15 | 1 | 94.1 |
| Ex. 6 | LiNi_{0.5}Mn_{1.5}O₄ | 5 | PMMA | SiO₂ | 0.5 | 1 | 76.4 |
| Ex. 7 | LiNi_{0.5}Mn_{1.5}O₄ | 5 | PMMA | SiO₂ | 1 | 1 | 94.7 |
| Ex. 8 | LiNi_{0.5}Mn_{1.5}O₄ | 5 | PMMA | SiO₂ | 30 | 1 | 92.7 |
| Ex. 9 | LiNi_{0.5}Mn_{1.5}O₄ | 5 | PMMA | SiO₂ | 100 | 1 | 88.2 |
| Ex. 10 | LiNi_{0.5}Mn_{1.5}O₄ | 5 | PMMA | SiO₂ | 300 | 1 | 85.9 |
| Ex. 11 | LiNi_{0.5}Mn_{1.5}O₄ | 5 | PMMA | SiO₂ | 400 | 1 | 75.0 |
| Ex. 12 | LiNi_{0.5}Mn_{1.5}O₄ | 5 | PMMA | SiO₂ | 15 | 0.05 | 76.6 |
| Ex. 13 | LiNi_{0.5}Mn_{1.5}O₄ | 5 | PMMA | SiO₂ | 15 | 0.1 | 87.8 |
| Ex. 14 | LiNi_{0.5}Mn_{1.5}O₄ | 5 | PMMA | SiO₂ | 15 | 10 | 86.2 |
| Ex. 15 | LiNi_{0.5}Mn_{1.5}O₄ | 5 | PMMA | SiO₂ | 15 | 15 | 76.3 |
| Comp. | LiNi_{0.5}Mn_{1.5}O₄ | 5 | — | — | — | — | 60.9 |
| Ex. 1 | | | | | | | |
| Comp. | LiNi_{0.5}Mn_{1.5}O₄ | 5 | — | — | — | — | 65.4 |
| Ex. 2* | | | | | | | |
| Comp. | LiCoO₂ | 4.2 | PMMA | SiO₂ | 15 | 1 | 90.2 |
| Ex. 3 | | | | | | | |
| Comp. | LiCoO₂ | 4.2 | — | — | — | — | 91.0 |
| Ex. 4 | | | | | | | |
| Comp. | LiNi_{0.5}Mn_{1.5}O₄ | 5 | SBR | SiO₂ | 15 | 1 | 67.8 |
| Ex. 5 | | | | | | | |

Note:
the asterisk “*” indicates that 1,3-propane sultone was added to the non-aqueous electrolyte.

The battery of COMPARATIVE EXAMPLE 1, in which the coating film was not formed on the surface of the positive electrode material mixture, exhibited an extremely low capacity retention rate. Presumably, this is due to the influence of decomposition of non-aqueous electrolyte by oxidation occurred at the surface of the positive electrode active material.

The battery of COMPARATIVE EXAMPLE 2, in which 1,3-propane sultone was added to the non-aqueous electrolyte, exhibited a better capacity retention rate than the battery of COMPARATIVE EXAMPLE 1. The capacity retention rate, however, was not so high. The reason is presumably because an excess coating film was formed on the negative electrode.

The battery of COMPARATIVE EXAMPLE 5, in which instead of polymethyl methacrylate, styrene butadiene rubber (SBR) was used as the polymer contained in the coating film, also exhibited a low capacity retention rate. This is presumably because the styrene butadiene rubber decomposed by oxidation in a high voltage range.

In contrast to the batteries of COMPARATIVE EXAMPLEs 1, 2 and 5, the batteries of the present invention (EXAMPLEs 1 to 15), in which the coating film comprising polymethyl methacrylate and the inorganic fine particles was formed on the positive electrode material mixture, exhibited excellent cycle characteristics.

The battery of COMPARATIVE EXAMPLE 3 containing LiCoO₂ having a redox potential of less than 4.5 V (vs. Li) as a positive electrode active material also exhibited excellent cycle characteristics. The battery of COMPARATIVE EXAMPLE 4, in which LiCoO₂ was used as a positive electrode active material and the coating film was not formed on the surface of the positive electrode material mixture, also exhibited cycle characteristics similar to those of the battery of COMPARATIVE EXAMPLE 3 In other words, no significant difference was observed between the batteries of COMPARATIVE EXAMPLEs 3 and 4. In the case of the batteries whose positive electrode active material has a redox potential of less than 4.5 V (vs. Li), the end-of-charge voltage is set lower than that of the batteries of the present invention. For this reason, in the batteries of COMPARATIVE EXAMPLEs 3 and 4, regardless of whether the coating film is present or not, the decomposition of non-aqueous electrolyte by oxidation hardly occurs.

The batteries of the present invention can retain a higher open circuit voltage (about 4.7 V) than that (4.2 V) of the batteries of COMPARATIVE EXAMPLEs 3 and 4.

For the batteries containing LiCoO₂ as a positive electrode active material, if its end-of-charge voltage is increased to, for example, 5 V, the batteries will exhibit an extremely low capacity retention rate.

The battery of COMPARATIVE EXAMPLE 3 exhibited a discharge capacity at the first cycle of 10 mAh. This discharge capacity is about 6% lower than that (10.6 mAh) of the battery of EXAMPLE 1. When a comparison of discharge capacity at the first cycle is made between the batteries of COMPARATIVE EXAMPLEs 3 and 4, the battery of COMPARATIVE EXAMPLE 3 has a slightly lower discharge capacity.

The battery of EXAMPLE 6 in which the amount of inorganic fine particles was less than 1 part by weight per 100 parts by weight of the polymer exhibited slightly low cycle characteristics. This is presumably because the ionic conductivity of the coating film was low. The battery of EXAMPLE 11 in which the amount of inorganic fine particles was above 300 parts by weight also exhibited slightly low cycle characteristics. Because the amount of inorganic fine particles was large in the battery of EXAMPLE 11, the amount of non-aqueous electrolyte retained at the surface of inorganic fine particle was also large. Moreover, as the ratio of polymer contained in the coating film was small, the entire coating film was porous. Therefore, more non-aqueous electrolyte came in contact with the positive electrode having a high potential. For this reason, it is presumed that the effect of the coating film to prevent the decomposition of non-aqueous electrolyte by oxidation decreased.

From the above results, it can be seen that preferred amount of the inorganic fine particles contained in the coating film is 1 to 300 parts by weight, more preferably 1 to 100 parts by weight, and particularly preferably 1 to 30 parts by weight per 100 parts by weight of the polymer.

The battery of EXAMPLE 12 whose coating film had a thickness less than 0.1 μm exhibited slightly low cycle characteristics. This is presumably because a uniform coating film was not formed on the surface of the positive electrode material mixture and part of the positive electrode material mixture surface was exposed. The battery of EXAMPLE 15 whose coating film had a thickness exceeding 10 μm also exhibited slightly low cycle characteristics. This is presumably because the coating film was too thick, which decreased the ionic conductivity of the coating film, increasing the reaction resistance.

From the above results, it can be seen that preferred thickness of the coating film is 0.1 to 10 μm.

According to the present invention, because the positive electrode potential can be increased without any difficulties, it is possible to provide a non-aqueous electrolyte secondary battery having a high energy density and excellent cycle characteristics. The non-aqueous electrolyte secondary battery of the present invention is applicable as, for example, a power source for portable devices that require high energy density or a power source for stationary applications.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising a positive electrode capable of absorbing and desorbing lithium, a negative electrode capable of absorbing and desorbing lithium, a separator, and a non-aqueous electrolyte,
wherein said positive electrode comprises a positive electrode active material having a redox potential of not less than 4.5 V relative to a lithium electrode,
a coating film is formed on a surface of said positive electrode, and
said coating film comprises inorganic fine particles and a polymer having a methyl methacrylate unit.

2. The non-aqueous electrolyte secondary battery in accordance with claim 1,
wherein said inorganic fine particles are contained in said coating film in an amount of 1 to 300 parts by weight per 100 parts by weight of said polymer.

3. The non-aqueous electrolyte secondary battery in accordance with claim 1,
wherein said coating film has a thickness of 0.1 to 10 μm.

4. The non-aqueous electrolyte secondary battery in accordance with claim 1,
wherein said inorganic fine particles comprise at least one selected from the group consisting of SiO₂, Al₂O₃, TiO₂, Y₂O₃ and MgO.
